(19) United States
(12) Patent Application Publication
(10) Pub. No.: US 2009/0252362 A1
(43) Pub. Date: Oct. 8, 2009

(54) HEARING DEVICE TO BE CARRIED IN THE AURICLE WITH AN INDIVIDUAL MOLD

(75) Inventors: Wai Loon Ooi, Singapore (SG); Andre Steinbuss, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/418,741

(22) Filed: Apr. 6, 2009

(30) Foreign Application Priority Data
Apr. 4, 2008 (DE) 10 2008 017 194.8

(51) Int. Cl. H04R 25/00; B29C 33/42

(52) U.S. Cl. 381/328; 264/222

(57) ABSTRACT

The wearing comfort of a hearing device designed as a mass-produced product, in particular a hearing aid, is improved. The hearing device is provided to be carried in an auricle. It comprises a housing which houses a sound signal processing device. A conductor conducts an acoustic or electric signal from the housing into an auditory canal of the user. A mold, which is individually fitted to a portion of the auricle of the user and provided with the housing in the form of a two-part design, is attached to the housing. The mold evenly distributes the pressure which the hearing aid exerts on adjacent sections of the auricle.

### CROSS-REFERENCE TO RELATED APPLICATION

This application claims the priority, under 35 U.S.C. §119, of German patent application DE 10 2008 017 194.8, filed Apr. 4, 2008; the prior application is herewith incorporated by reference in its entirety.

### BACKGROUND OF THE INVENTION

### Field of the Invention

The present invention relates to a hearing device to be carried in the helix or the cymba conchae of an auricle. The device comprises a housing in which a sound signal processing device is housed and a conductor for conducting an acoustic or electric signal from the housing into an auditory canal of a user. Moreover, the present invention relates to a method for producing a hearing device, suitable for being carried in the helix or in the cymba conchae of an auricle and having a housing with an integrated sound signal processing device. Here, the term “hearing device” is understood to mean any portable sound-emitting equipment in or on the ear, in particular a hearing aid, a headset, headphones and the like.

Hearing aids are portable hearing devices which serve those who are hard of hearing. In order to accommodate the many individual requirements, different designs of hearing aids are provided, such as behind the ear (BTE) hearing aids, receiver in the canal (RIC) and in the ear hearing aids (ITE), such as concha hearing aids or canal hearing aids (ITE, CIC) as well. The hearing aids listed in an exemplary manner are carried on the outer ear or in the auditory canal. Furthermore, bone anchored hearing aids and hearing aids which can be implanted or vibro-tactile hearing aids are also commercially available however. Here, the stimulation of the damaged hearing function is effected either mechanically or electrically.

In principle, the essential components of hearing aids are an input transducer, an amplifier and an output transducer. The input transducer is, in general, a sound receiver, such as a microphone, and/or an electromagnetic receiver such as an induction coil. The output transducer is, in general, implemented as an electroacoustic transducer, such as a miniature loudspeaker, or as an electromechanical transducer, such as a bone vibrator. The amplifier is usually integrated in a signal processing unit. This basic design is illustrated in FIG. 1 using the example of a behind the ear hearing aid. One or more microphones 2 for recording the sound from the surroundings is or are installed in a hearing aid housing 1 to be carried behind the ear. A signal processing unit 3, which is also integrated in the hearing aid housing 1, processes the microphone signals and amplifies them. The output signal of the signal processing unit 3 is transmitted to a loudspeaker or earpiece 4 which emits an acoustic signal. If necessary, the sound is transferred to the eardrum of the hearing-aid user via a sound tube which is fixed in the auditory canal by otoplasty. The energy supply of the hearing aid and in particular the signal processing unit 3 is ensured by a battery 5 which is also integrated in the hearing aid housing 1.

The desire for cost-effective and miniaturized hearing aids led to capsule-shaped equipment with a length of just over one centimeter and which can be carried in the helix or the cymba conchae. The output signal of the hearing aid is guided to the auditory canal through the concha by means of a sound tube or, in the case of an RIC hearing aid, with the aid of an electric conductor.

As far as it is possible, standard components are used in the hearing aid that can be carried in the helix in order to keep the price of the hearing aid as low as possible. This includes producing the housing of the hearing aid as a simple plastic injection-molding part. A housing such as this has a standard shape and is generally rigid. This means that the wearing comfort often leaves much to be desired. In particular, there are pressure points on the anti-helix or the crus of helix.

### SUMMARY OF THE INVENTION

It is accordingly an object of the invention to provide a hearing device with an individual mold piece which overcomes the above-mentioned disadvantages of the heretofore-known devices and methods of this general type and which improves the wearing comfort of a hearing device with a standard housing to be carried in the auricle. It is a further object to specify a method for producing such a hearing device.

With the foregoing and other objects in view there is provided, in accordance with the invention, a hearing device to be carried in an auricle, comprising:

a housing containing a sound signal processing device;

a conductor for conducting an acoustic or electric signal from said housing into an auditory canal of a user;

a mold individually matched to a part of the auricle of a given user, said mold being attached to said housing and forming with said housing a two-part design.

In other words, the objects of the invention are achieved by a hearing device to be carried in an auricle, comprising a housing in which a sound signal processing device is housed and a conductor for conducting an acoustic or electric signal from the housing into an auditory canal of a user, with a mold, which is individually matched to part of the auricle of the user and which is provided with the housing in the form of a two-part design, being attached to the housing.

Advantageously, the wearing comfort of an individually fitted housing can thus be attained using a hearing device with a standard housing.

The mold can be adhesively bonded (i.e., glued) to the housing. In this manner, it is stably fitted to the housing without using complex connecting components.

Alternatively, the mold can also be attached to the housing by means of a snap-on connection. This makes it possible for the mold to be very quickly mounted on the housing.

The mold is preferably elastic like a foam or rubbery-elastic. This further increases the wearing comfort since pressure points can be avoided as far as possible.

It is particularly advantageous for the part of the auricle to be the helix or the cymba conchae. This is because very small hearing aids with standard housing are designed to be carried in the helix or in the cymba conchae. There, they can be carried very comfortably and are not aesthetically obtrusive.

With the above and other objects in view there is also provided, in accordance with the invention, a method for producing a hearing device suitable for being carried in an auricle of a user, the method which comprises:

providing a housing with an integrated sound signal processing device;

detecting a shape of a part of the auricle;

forming a mold part that is individually matched to the part of the auricle of the user;

attaching the mold part to the housing to form a two-part design housing with the housing and the mold part suitable for being carried in the auricle of the user.

In other words, there is also provided a method for producing a hearing device, suitable for being carried in an auricle and having a housing with an integrated sound signal processing device, by detecting the shape of a part of the auricle, designing a mold which is individually matched to the part of the auricle of the user and which is provided with the housing in the form of a two-part design, and attaching the mold to the housing.

The mold is preferably produced using a stereolithographic method. The mold can thus be produced very rapidly and in an automated form.

Other features which are considered as characteristic for the invention are set forth in the appended claims.

Although the invention is illustrated and described herein as embodied in a hearing device to be carried in the auricle with an individual mold, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows the basic design of a hearing aid according to the prior art;

FIG. 2 shows a perspective illustration of a standard hearing aid to be carried in the cymba conchae;

FIG. 3 shows the hearing aid in accordance with FIG. 2 in a side view having a mold according to the invention; and

FIG. 4 shows the hearing aid in accordance with FIG. 3 in a state where it is being carried.

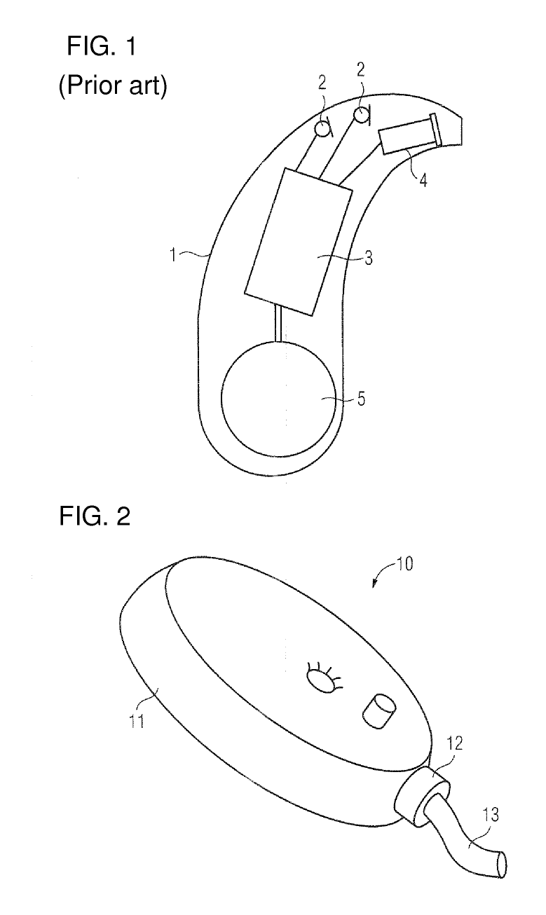

### DETAILED DESCRIPTION OF THE INVENTION

It will be understood that the exemplary embodiments described in more detail below are preferred embodiments of the present invention. However, before this, a hearing aid 10 to be carried in the helix or cymba conchae will be explained in more detail with reference to FIG. 2 for better understanding of the invention. The hearing aid comprises a standard injection-molded housing 11 with a fixed geometry. FIG. 4 shows how this hearing aid 10 is, in principle, carried in the auricle 17, i.e., the external ear 17. A conductor 13 is located at the output 12 of the hearing aid 10 so as to conduct an output signal into the auditory canal of the user. This conductor 13 can be a sound tube for leading an acoustic signal to the auditory canal. In the case of RIC (receiver in the canal) equipment, the conductor 13 is a thin cable by means of which corresponding electric signals are transmitted to an earpiece in the auditory canal.

On the one hand, it is advantageous that the fixed geometry of the housing 11 of the hearing aid 10 can, as a mass-produced product, be produced very cost-effectively for a large number of users with an unchanging shape. However, on the other hand, since the auricles of the hearing-aid users are always shaped individually, the hearing aid is either fitted very loosely or an uncomfortable pressure is exerted on certain areas of the cymba. The more localized this pressure is, the more uncomfortable it is. However, if there is only very little or no pressure exerted on the region of the cymba, i.e. if the cymba conchae is slightly larger than the average cymba conchae, there is always the risk of the hearing aid falling out of the auricle.

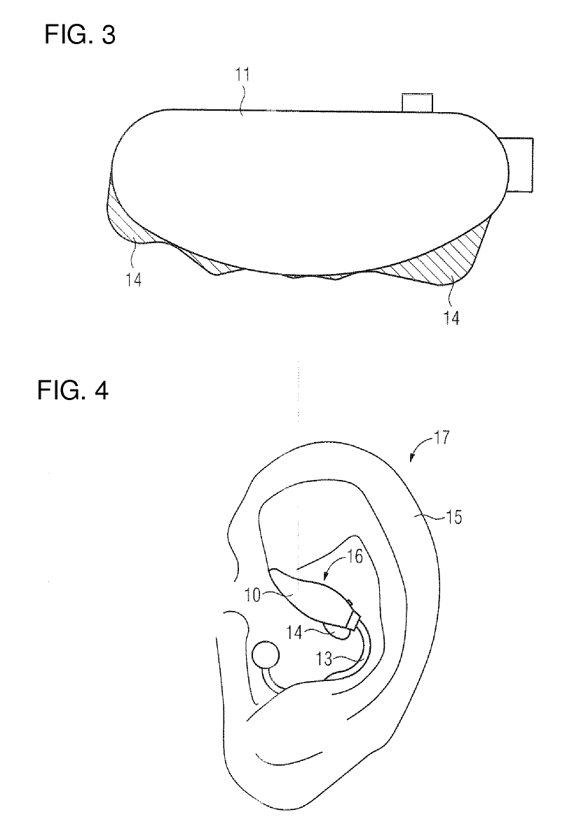

Noting the above-mentioned problems, according to the invention provision is now made for a mold part 14, or mold for short, to be fitted to the hearing aid housing 11 in accordance with FIG. 3 in order to individually shape the outer contours of the housing 11 in that area in which the hearing aid 10 contacts the auricle, in particular where it contacts the helix or the cymba conchae. In order to obtain the mold 14, an ear imprint of the desired part of the helix or the cymba conchae is made. Alternatively, data regarding the shape of the auricle or a region thereof can also be obtained by scanning.

The mold 14 is now produced separately from the housing 11, based on the ascertained individual shape of the part of the auricle. The contour of the mold 14 then exactly corresponds to the negative contour of that part of the auricle 17 into which the hearing aid is to be inserted (cf. FIG. 4), for example the helix 15 or the cymba conchae 16.

The individual matching of the mold 14 to the present auricle leads to a smaller deformation of that part of the auricle 17 in which the hearing aid 10 is inserted whilst having the same holding force. This increases the wearing comfort because the mold 14 transmits the pressure to the adjacent parts of the auricle evenly. Furthermore, the risk of the hearing aid 10 falling out is reduced by the mold 14, because said mold 14 provides a certain amount of form fit.

The mold 14 equalizes gaps and pressure points. So as to be able to fulfill this function in an even more improved manner, the material of the mold 14 can be soft, in particular it can be rubbery-elastic or in the form of a foam.

The mold 14 can be produced using a conventional SLA technique within the scope of an RSM (rapid shell manufacturing) method. This ensures a high degree of automation.

Since the hearing aid is not placed in the concha or in the auditory canal, an open supply can easily be implemented, like in BTE hearing aids. In particular, as discussed above, an RIC solution is possible, which not only leads to high wearing comfort, but is also advantageous from an aesthetic point of view.

In practice, a user will acquire a hearing aid which is available as a mass-produced product. An audiologist makes an ear imprint of that part of the ear in which the hearing aid is carried. Alternatively, the audiologist scans said part of the ear. Subsequently, the corresponding individual mold is produced. Finally, the mold is adhesively bonded, plugged, clipped or otherwise attached onto the housing 11 of the hearing aid 10. Thus, the hearing aid originally obtained as a mass-produced product has been individualized for comfortable wearing.

1. A hearing device to be carried in an auricle, comprising:
a housing containing a sound signal processing device;
a conductor for conducting an acoustic or electric signal from said housing into an auditory canal of a user;
a mold individually matched to a part of the auricle of a given user, said mold being attached to said housing and forming with said housing a two-part design.

2. The hearing device according to claim 1, wherein said mold is adhesively bonded to said housing.

3. The hearing device according to claim 1, wherein said mold is attached to said housing by way of a snap-on connection.

4. The hearing device according to claim 1, wherein said mold is a rubbery-elastic part.

5. The hearing device according to claim 1, wherein said mold is matched to the helix or to the cymba conchae of the auricle.

6. A method for producing a hearing device suitable for being carried in an auricle of a user, the method which comprises:
providing a housing with an integrated sound signal processing device;
detecting a shape of a part of the auricle;
forming a mold part that is individually matched to the part of the auricle of the user;
attaching the mold part to the housing to form a two-part design housing with the housing and the mold part suitable for being carried in the auricle of the user.

7. The method according to claim 6, which comprises forming the mold part with a stereolithographic process.

8. The method according to claim 6, which comprises detecting the shape of the helix or the cymba conchae of the auricle and individually matching the mold part to the helix or the cymba conchae.
